(19) United States
(12) Patent Application Publication
(10) Pub. No.: US 2006/0157940 A1
(43) Pub. Date: Jul. 20, 2006

(54) Sealing device for shock-absorbers

(75) Inventors: Stellario Barbera, Torino (IT); Riccardo Restivo, Torino (IT)

Correspondence Address: MERCHANT & GOULD PC, P.O. BOX 2903, MINNEAPOLIS, MN, 55402-0903, US

(73) Assignee: RFT S.p.A., Torino (IT)

(21) Appl. No.: 11/313,430

(22) Filed: Dec. 20, 2005

(30) Foreign Application Priority Data
Dec. 21, 2004 (IT) TO2004A000890

(51) Int. Cl. F16J 15/32

(52) U.S. Cl. 277/572

(57) ABSTRACT

The device includes an annular body (10) of rubber or elastomeric material associated with an annular reinforcing insert (20). The body (10) forms an oil-guard lip (15), a dust-cover lip (12) and a peripheral static sealing lip (13). The insert (20) is produced from plastics material and forms a discoidal annular portion (21) for supporting and connecting the lips (12, 13, 15). The insert (20) also forms a reinforcing structure (22) which projects axially from a radially internal region of the discoidal portion (21) and which is attached to the oil-guard lip (15) in order to ensure that that lip exerts controlled radial contact pressure against the stem (S) of a shock-absorber.

The present invention relates to a sealing device for shock-absorbers of the type defined in the preamble of claim 1.

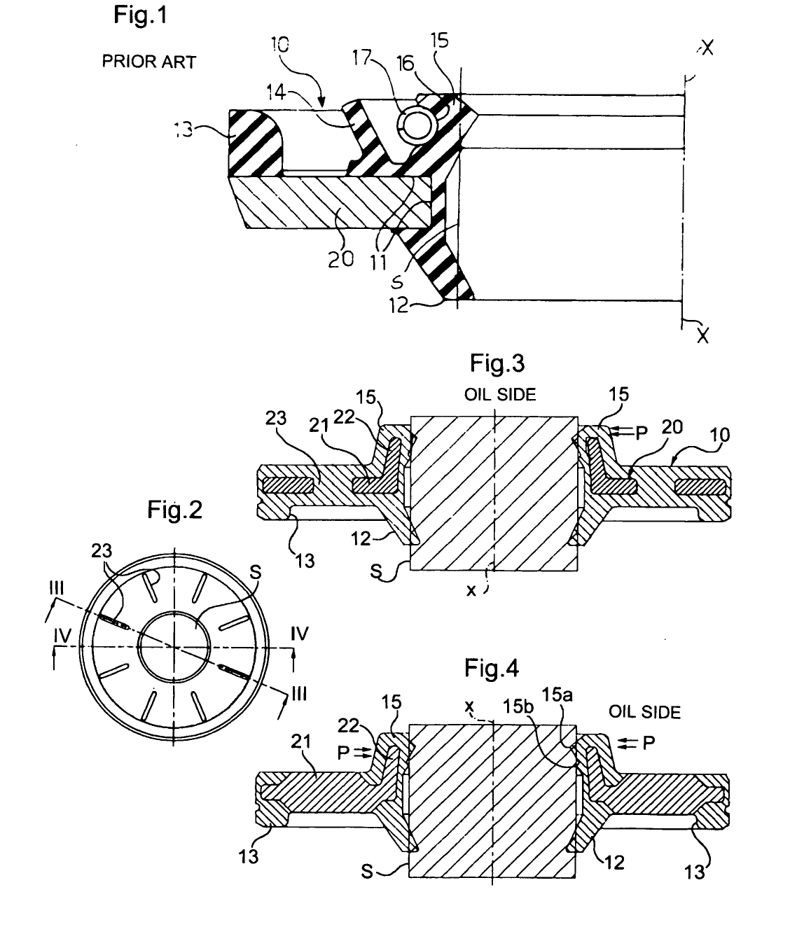

Sealing devices of the type illustrated diagrammatically in FIG. 1 of the appended drawings are currently known. Referring to FIG. 1, a sealing device of the conventional type comprises a generally annular rubber body 10 having a cross-section shaped to define various parts suitable for performing various respective functions. The rubber body 10 defines in its central region an external circumferential groove 11 having a generally rectangular cross-section in which is partially inserted a metal insert 20 in the shape of an annular disc which acts as a support element for the rubber body 10 and as a reinforcement for supporting the axial loads to which the sealing device is subjected on the oil side during the functioning thereof. On the axially lower side with respect to the metal insert 20, the rubber body 10 defines a conical dust-cover lip 12 projecting in a radially internal direction. On the opposite side or on the axially upper side with respect to the metal insert 20, the body 10 defines three coaxial lips 13, 14, 15, namely a radially external lip 13 for static sealing, an optional intermediate lip 14 and a radially internal oil-guard lip 15 which is urged in the radially internal direction by a circumferential spring 17 positioned in a groove 16 formed in a radially external surface of the oil-guard lip 15 to ensure the sliding contact pressure of that lip against the stem of a shock-absorber (indicated schematically at S).

It has been found that, in conventional devices of the above-mentioned type, the oil-guard lip tends to be excessively squashed in the radially internal direction owing to the high pressures of the oil. Therefore, increasing the area of contact between the oil-guard lip and the stem of the shock-absorber also increases the sliding wear at the interface between those two components when the stem moves in translation axially with respect to the sealing device. In the field of shock-absorbers, there is currently an ever increasing demand to reduce the sliding wear as much as possible in order to have an ever more rapid response from the shock-absorbers.

A principal object of the present invention is to provide an improved sealing device for shock-absorbers which is capable of reducing the friction forces which develop against the stem, maintaining the performance unaltered in terms of sealing with respect to the oil.

A further object of the invention is to provide a sealing device which is less expensive and lighter compared to conventional devices.

Those objects are achieved in accordance with the present invention by a sealing device having the features defined in the appended claims.

A description will now be given of the structural and functional features of some preferred but non-limiting embodiments of a device according to the invention; reference will be made to the appended drawings in which identical reference numerals denote identical or corresponding parts in the various Figures. In the drawings:

FIG. 1 is a view of a sealing device of the conventional type in partial axial section;

FIG. 2 is a plan view of a first embodiment of a sealing device according to the invention;

FIGS. 3 and 4 are two views in axial section, on an enlarged scale, according to the respective lines III-III and IV-IV of FIG. 2;

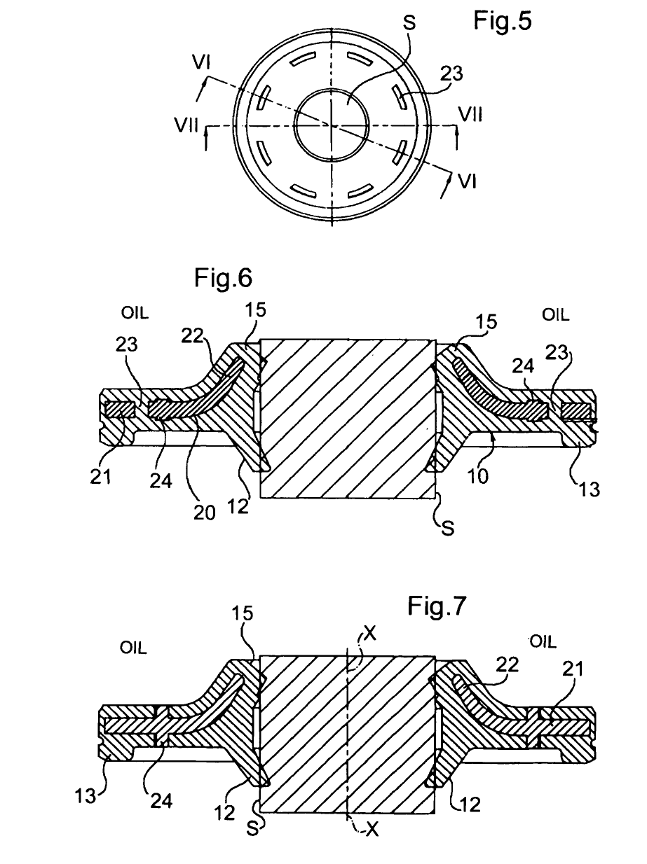

FIG. 5 is a plan view of a second embodiment of a sealing device according to the invention; and

FIGS. 6 and 7 are two views in axial section, on an enlarged scale, according to the respective lines VI-VI and VII-VII of FIG. 5.

Referring now to FIGS. 2 to 4, a sealing device according to the invention differs from the conventional device illustrated in FIG. 1 principally by the presence of an annular discoidal insert 20 of plastics material, having the forms described in detail hereinafter, which replaces the conventional metal insert.

The sealing device comprises a generally annular body 10 of rubber or elastomeric material moulded over a reinforcing insert 20 of plastics material. The insert 20 has a radially external portion 21 in the form of a discoidal flange, and a radially internal portion 22 which extends from one side of the discoidal portion 21 (towards the “oil side”), forming a substantially axial or slightly frustoconical tubular appendage which tapers away from the discoidal portion 21.

In the present text, the terms and expressions indicating positions and orientations, such as “axial” and “radial” or “transverse” are intended to refer to the central geometric axis x of the sealing device, coinciding with the central longitudinal axis of the shock-absorber on which the device is to be fitted.

The rubber body 10 defines an oil-guard lip 15 which covers the appendage 22 of the insert 20 at least on the radially internal side of the latter (which, in use, faces the stem S of the shock-absorber), a conventional frustoconical dust-cover lip 12 on the side opposite the oil-guard lip 15, and a conventional static sealing lip 13, which can project equally well towards the oil side or towards the opposite side, depending on the type of shock-absorber.

In order to contact the stem S in a sliding manner, the oil-guard lip 15 has a conventional principal sliding contact formation 15a in the shape of a right-angle on the radially internal side, and a secondary sliding contact formation 15b which is spaced axially from the principal formation 15a. It should be noted that in all of the drawings, the various lips of the rubber body 10 are illustrated in the non-deformed condition.

The appendage 22 acts as a reinforcing structure for the oil-guard lip 15 in order to ensure that that lip exerts a correct and controlled radial contact pressure against the stem S. In practice, the appendage 22 opposes the radial component P of the oil pressure which tends to squash the lip 15 against the stem. It will be appreciated that the appendage 22 advantageously enables the conventional circumferential spring mentioned above to be eliminated and therefore the production costs of the spring and the time associated with the assembly thereof on the sealing device to be reduced. In addition, the plastics material constituting the insert 20 (for example, polyamide) confers on the appendage 22 the desired degree of flexibility in an axial plane.

It will also be appreciated that the choice of using an insert of plastics material is advantageous in terms of lightness and costs compared with a conventional metal insert. In particular, plastics material is suitable in an optimum manner for obtaining complex shapes, which are readily obtainable by moulding techniques. It is advantageously possible to form in the insert 20 raised portions and/or recesses, such as, for example, axial slits or notches 23, on which or in which there are produced, by overmoulding, complementary rubber formations which co-operate with those raised portions/recesses in order to improve anchorage between the rubber body 10 and the insert 20.

In the embodiment of FIGS. 3 and 4, the appendage 22 extends at an obtuse angle from the radial flange portion 21. According to an alternative embodiment of the invention, as illustrated in FIGS. 5 to 7, the appendage 22 can be joined to the flange 21 by means of a curved connecting portion in order to render the appendage more flexible. The numeral 24 indicates raised portions having functions analogous to those mentioned above with reference to the notches or openings 23.

It will be appreciated that the invention is not limited to the embodiments described and illustrated here, which are to be regarded as examples of the sealing device; on the contrary, the invention can be modified in respect of shape, dimensions and arrangements of parts, structural details and materials used. For example, according to an alternative embodiment (not shown), the appendage 22 could be constituted by a plurality of circumferentially adjacent resilient tongues which have a cross-sectional shape identical or similar to those illustrated in FIGS. 3, 4 and 6, 7, but which are spaced at an equal distance from one another in the circumferential direction. Finally, the rubber body 10 could also define lips other than those illustrated in FIGS. 2 to 7, for example an intermediate lip of the type indicated 14 in FIG. 1.

What is claimed is:

1. A sealing device for shock-absorbers, of the type comprising a generally annular body of rubber or elastomeric material associated with an annular reinforcing insert,
wherein the body forms, in a radially internal position or centrally, an oil-guard lip and a dust-cover lip which project axially on opposite sides in order to contact in a sliding manner a stem of a shock-absorber, and, in a radially external position or peripherally, a static sealing lip,
and wherein the insert comprises a substantially annular discoidal portion for supporting and connecting the lips;
wherein the insert is produced from plastics material and also forms a reinforcing structure which projects axially from a radially internal region of the discoidal portion and which is attached to the oil-guard lip in order to ensure that that lip exerts a controlled radial contact pressure against the stem.

2. The sealing device of claim 1, wherein the reinforcing structure extends from one side of the discoidal portion, and has a substantially axial or slightly frustoconical generally tubular shape which tapers away from the discoidal portion.

3. The sealing device of claim 2, wherein the reinforcing structure comprises a substantially axial or slightly frustoconical tubular appendage which tapers away from the discoidal portion.

4. The sealing device of claim 1, wherein the reinforcing structure extends at an obtuse angle from the discoidal portion.

5. The sealing device of claim 1, wherein the reinforcing structure is joined to the discoidal portion by means of a curved connecting portion.

6. The sealing device of claim 1, wherein the body is overmoulded or vulcanized on the plastics insert, and in that the insert has recesses and/or raised portions on which or in which there are produced, by overmoulding, complementary rubber formations which co-operate with the raised portions and/or recesses in order to improve anchorage between the body and the reinforcing insert.

7. The sealing device of claim 6, wherein the recesses comprise axial openings or notches formed in the discoidal portion.

8. The sealing device of claim 1, wherein the insert is made of polyamide.

9. The sealing device of claim 1, wherein the body also forms at least a fourth sealing lip.
